(19) United States
(12) Patent Application Publication
(10) Pub. No.: US 2023/0246459 A1
(43) Pub. Date: Aug. 3, 2023

(54) BATTERY APPARATUS AND METHOD OF SUPPLYING VOLTAGE

(71) Applicant: LG ENERGY SOLUTION, LTD., Seoul (KR)

(72) Inventor: Sungwoo LEE, Daejeon (KR)

(73) Assignee: LG ENERGY SOLUTION, LTD., Seoul (KR)

(21) Appl. No.: 17/789,583

(22) PCT Filed: Dec. 27, 2021
(86) PCT No.: PCT/KR2021/019911

§ 371 Date: Jun. 28, 2022

(30) Foreign Application Priority Data
Jan. 8, 2021 (KR) 10-2021-0002663

(51) Int. Cl. H02J 7/00; H01M 10/46; H01M 10/44

(52) U.S. Cl. CPC H02J 7/0019; H01M 10/46; H01M 10/441; H02J 7/007; H01M 2010/4271

(57) ABSTRACT

A battery apparatus including a first battery pack for providing a first voltage, a battery management system for managing the first battery pack, and a second battery pack for providing a second voltage lower than the first voltage is provided. The second battery pack includes a plurality of battery cells, and the battery management system selects a battery cell group including a predetermined number of battery cells from among the plurality of battery cells of the second battery pack. The selected battery cell group supplies an operating voltage to an operating device of the battery management system.

### TECHNICAL FIELD

### Cross-Reference To Related Application

This application claims priority to and the benefit of Korean Patent Application No. 10-2021-0002663 filed in the Korean Intellectual Property Office on Jan. 8, 2021, the entire contents of which are incorporated herein by reference.

The described technology relates to a battery apparatus and a method of supplying a voltage.

### Background Art

An electric vehicle or a hybrid vehicle is a vehicle that obtains power by driving a motor mainly using a battery as a power supply. The electric vehicles are being actively researched because they are alternatives that can solve pollution and energy problems of internal combustion vehicles. Rechargeable batteries are used in various external apparatuses other than the electric vehicles.

The battery apparatus includes a battery pack and a battery management system for managing the battery pack. The battery management system monitors various information such as a voltage, a state of charge and a temperature of battery cells included in the battery and includes various circuits for monitoring the various information.

Currently, a power source for supplying power to electronic components is used to supply power to the battery management system. However, since a voltage (e.g., 12V) supplied from the power supply for supplying the power to the electronic components is higher than an operating voltage (e.g., 5V) of the battery management system, a component for lowering the voltage of the power supply is required. When the voltage is lowered in this way, electromagnetic interference (EMI) may occur in a DC/DC (direct current to direct current) converter, power consumption may increase due to a low dropout (LDO) regulator, and additional components may be required for voltage stabilization.

### DISCLOSURE

### Technical Problem

Some embodiments may provide a battery apparatus and a method of supplying a voltage capable of supplying an operating voltage of a battery management system without using a component for voltage drop.

### Technical Solution

According to an embodiment, a battery apparatus including a first battery pack configured to provide a first voltage, a battery management system configured to manage the first battery pack, and a second battery pack configured to provide a second voltage lower than the first voltage may be provided. The second battery pack may include a plurality of battery cells, and the battery management system may select a battery cell group including a predetermined number of battery cells from among the plurality of battery cells of the second battery pack. The selected battery cell group may supply an operating voltage to an operating device of the battery management system.

In some embodiments, the first voltage of the first battery pack may not be provided as the operating voltage.

In some embodiments, the operating voltage may correspond to a sum of voltages of the predetermined number of battery cells.

In some embodiments, a first wire connected to a negative electrode of a first battery cell among the predetermined number of battery cells may be connected to a ground terminal of the operating device, and a second wire connected to a positive electrode of a last battery cell among the predetermined number of battery cells may be connected to an operating voltage supply terminal of the operating device.

In some embodiments, the plurality of battery cells of the second battery pack may be grouped into a plurality of battery cell groups, and each of the plurality of battery cell groups may include battery cells corresponding to the predetermined number. The battery management system may select the battery cell group from among the plurality of battery cell groups.

In some embodiments, the battery management system may alternately select one battery cell group from among the plurality of battery cell groups at a predetermined time interval.

In some embodiments, the battery management system may further include a switching circuit configured to select the plurality of battery cell groups.

In some embodiments, the plurality of battery cell groups may include a first battery cell group and a second battery cell group. In response to selecting the first battery cell group, the switching circuit may connect a first wire connected to a negative electrode of a first battery cell among the predetermined number of battery cells in the first battery cell group to a ground terminal of the operating device, and connect a second wire connected to a positive electrode of a last battery cell among the predetermined number of battery cells in the first battery cell group to an operating voltage supply terminal of the operating device. In response to selecting the second battery cell group, the switching circuit may connect a third wire connected to a negative electrode of a first battery cell among the predetermined number of battery cells in the second battery cell group to the ground terminal, and connect a fourth wire connected to a positive electrode of a last battery cell among the predetermined number of battery cells in the second battery cell group to the operating voltage supply terminal.

In some embodiments, the switching circuit may include a first switch connected between the first wire and the ground terminal, a second switch connected between the second wire and the operating voltage supply terminal, a third switch connected between the third wire and the ground terminal, and a fourth switch connected between the fourth wire and the operating voltage supply terminal. The battery management system may select the first battery cell group by turning on the first switch and the second switch, and may select the second battery cell group by turning on the third switch and the fourth switch.

In some embodiments, the operating device may include a processor.

According to another embodiment, a method of supplying a voltage in a battery apparatus including a first battery pack configured to supply a first voltage, a second battery pack configured to supply a second voltage lower than the first voltage, and a battery management system configured to manage the first battery pack may be provided. The method may include selecting a first battery cell group including a predetermined number of battery cells from among a plurality of battery cells included in the second battery pack, and supplying an operating voltage to an operating device of the battery management system through the first battery cell group.

In some embodiments, the method may further include selecting a second battery cell group including the predetermined number of other battery cells from among the plurality of battery cells in response to a predetermined time elapsing after selecting the first battery cell group, and supplying the operating voltage to the operating device of the battery management system through the second battery cell group.

According to yet another embodiment, a battery apparatus including a battery pack including a plurality of battery cells and a battery management system may be provided. The battery management system may group the plurality of battery cells of the battery pack into a plurality of battery cell groups each including a predetermined number of battery cells, alternately select one battery cell group from among the plurality of battery cell groups, and providing an operating voltage to an operating device of the battery management system through the selected battery cell group.

### ADVANTAGEOUS EFFECTS

According to some embodiments, it is possible to supply the operating voltage of the battery management system without using a component for lowering the voltage of the power supply.

### DESCRIPTION OF THE DRAWINGS

FIG. 1 is a diagram showing a battery apparatus according to an embodiment.

FIG. 2 is a diagram for explaining supply of an operating voltage of a battery management system according to an embodiment.

FIG. 3 and FIG. 4 are diagrams for explaining supply of an operating voltage of a battery management system according to another embodiment.

FIG. 5 is a diagram showing an example of a switching circuit shown in FIG. 3.

FIG. 6 is a flowchart showing a voltage supply method according to another embodiment.

### MODE FOR INVENTION

In the following detailed description, only certain embodiments have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

When it is described that an element is “connected” to another element, it should be understood that the element may be directly connected to the other element or connected to the other element through a third element. On the other hand, when it is described that an element is “directly connected” to another element, it should be understood that the element is connected to the other element through no third element.

As used herein, a singular form may be intended to include a plural form as well, unless the explicit expression such as “one” or “single” is used.

In flowcharts described with reference to the drawings, the order of operations or steps may be changed, several operations or steps may be merged, a certain operation or step may be divided, and a specific operation or step may not be performed.

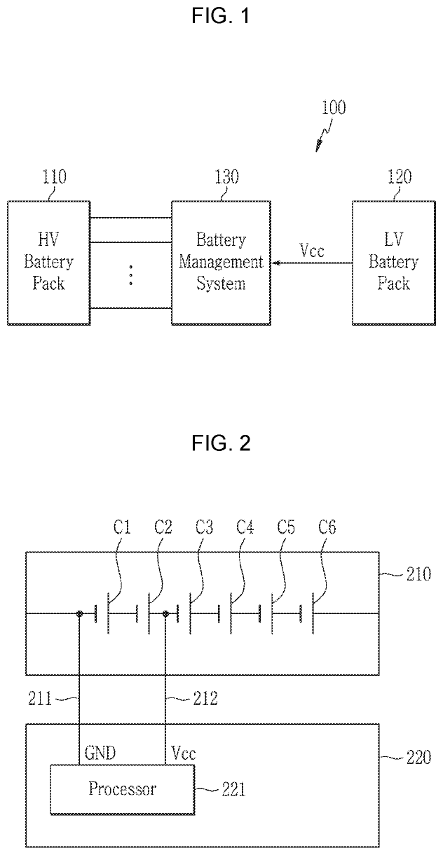

FIG. 1 is a diagram showing a battery apparatus according to an embodiment.

Referring to FIG. 1, a battery apparatus 100 includes a high voltage (HV) battery pack 110, a low voltage (LV) battery pack 120, and a battery management system (BMS) 130.

The battery apparatus 100 has a structure that can be electrically connected to an external apparatus. When the external apparatus is a load, the battery apparatus 100 is discharged by operating as a power supply that supplies power to the load. The external apparatus 10 operating as the load may be, for example, an electronic device, a mobility apparatus, or an energy storage system (ESS). The mobility apparatus may be, for example, a vehicle such as an electric vehicle, a hybrid vehicle, or a smart mobility.

The HV battery pack 110 outputs a relatively high voltage and supplies power to a large-capacity load of the external apparatus. The LV battery pack 120 outputs a relatively low voltage and supplies power to a low-capacity load of the external apparatus. The voltage supplied from the HV battery pack 110 is higher than the voltage supplied from the LV battery pack 120. In some embodiments, the large-capacity load may be a load for driving the vehicle, including, for example, a motor of the vehicle. In some embodiments, the low-capacity load of the external apparatus may be a load used to control the vehicle, for example, an electrical component.

The HV battery pack 110 and the LV battery pack 120 each include a plurality of battery cells (not shown). In some embodiments, the battery cell may be a rechargeable cell. Each battery pack 110 or 120 may include a battery module in which a predetermined number of battery cells are connected in series. In some embodiments, in each battery pack 110 or 120, a predetermined number of battery modules may be connected in series or in parallel to supply desired power.

The HV battery pack 110 is connected to the battery management system 130 through wires (not shown). For example, each of the plurality of battery cells of the HV battery pack 110 may be connected to the battery management system 130 through the wire. The battery management system 130 may include a processor 131. The processor 131 may collect and analyze various information about the battery cells to control charging and discharging of the battery cells, a cell balancing operation, a protection operation, and the like. In some embodiments, the processor 131 may be, for example, a micro controller unit (MCU). In some embodiments, the battery management system 130 may further include various monitoring circuits (not shown) such as cell voltage monitoring circuits.

In some embodiments, the battery management system 130 may collect and analyze various information about the battery cells of the LV battery pack 120 to control charging and discharging of the battery cells, a cell balancing operation, a protection operation, and the like.

In some embodiments, the battery apparatus 110 may further include a separate battery management system (not shown) for the LV battery pack 120.

An operating device of the battery management system 130, for example, the processor 131 of the battery management system 130 may be operated by receiving an operating voltage. To this end, some battery cells of the LV battery pack 120 may supply the operating voltage Vcc for the battery management system 130. Accordingly, a DC/DC converter for lowering the voltage of the power supply, an LDO regulator, and components for voltage stabilization may not be used. In some embodiments, the voltage of the HV battery pack 110 may be not provided as the operating voltage Vcc, and only the LV battery pack 120 may supply the operating voltage Vcc. Accordingly, the power supplied to the large-capacity load may not be affected by the supply of the operating voltage Vcc.

FIG. 2 is a diagram for explaining supply of an operating voltage of a battery management system according to an embodiment.

Referring to FIG. 2, an LV battery pack 210 includes a plurality of battery cells connected in series. Although six battery cells C1, C2, C3, C4, C5, and C6 are shown in FIG. 2 for convenience of description, the number of battery cells included in the LV battery pack is not limited thereto.

Among the plurality of battery cells of the LV battery pack 210, some adjacent battery cells C1 and C2 form one battery cell group to supply an operating voltage to a battery management system 220. For example, when a voltage of each battery cell of the LV battery pack 210 is 2.5V and the operating voltage of the battery management system 220 is 5V, the two battery cells C1 and C2 may supply the operating voltage.

In the battery cell group, wires 211 and 212 are connected to a negative electrode of the first battery cell C1 and a positive electrode of the last battery cell C2, respectively. The wire 211 is connected to a terminal corresponding to a ground potential of the battery management system 220, and the wire 212 is connected to a terminal for supplying the operating voltage of the battery management system 220. In some embodiments, as shown in FIG. 2, the wire 211 may connected to the ground terminal of the processor 221 of the battery management system 220, i.e., a ground pin GND, and the wire 212 may be connected to an operating voltage supply terminal of the processor 221, i.e., an operating voltage supply pin Vcc.

Accordingly, a sum (e.g., 5V) of voltages of the battery cells C1 and C2 included in the battery cell group may be supplied as the operating voltage of the battery management system 220.

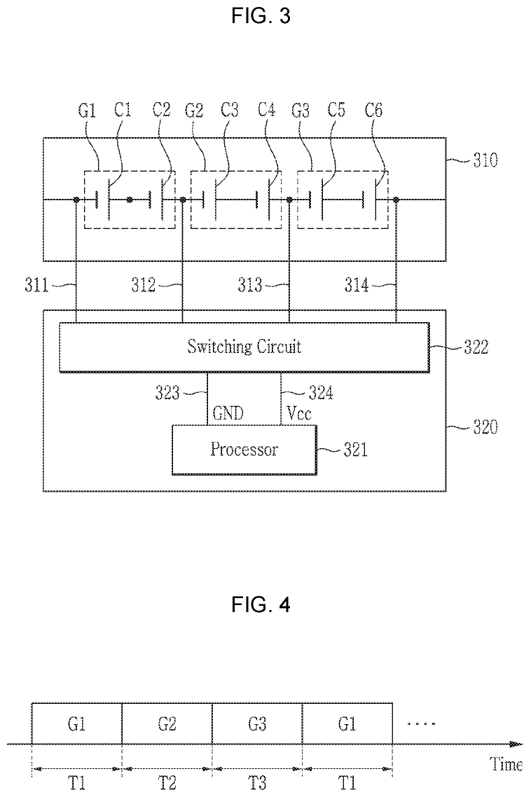

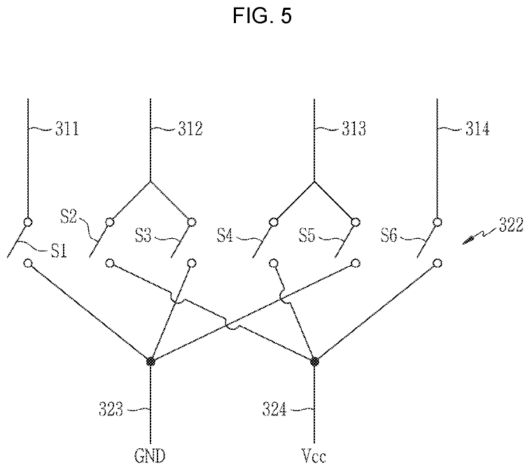

FIG. 3 and FIG. 4 are diagrams for explaining supply of an operating voltage of a battery management system according to another embodiment, and FIG. 5 is a diagram showing an example of a switching circuit shown in FIG. 3.

Referring to FIG. 3, an LV battery pack 310 includes a plurality of battery cells connected in series. Although six battery cells C1, C2, C3, C4, C5, and C6 are shown in FIG. 3 for convenience of description, the number of battery cells included in the LV battery pack is not limited thereto.

A plurality of battery cells of the LV battery pack 310 are grouped into a plurality of battery cell groups G1, G2, and G3, and each battery cell group Gi includes battery cells that can supply a voltage corresponding to the operating voltage of the battery management system 320. Here, i is an integer from 1 to 3. For example, when a voltage of each battery cell of the LV battery pack 210 is 2.5V and the operating voltage of the battery management system 320 is 5V, each battery cell group Gi may include two adjacent battery cells. That is, one battery cell group G1 may include two battery cells C1 and C2, another battery cell group G2 may include two other battery cells C3 and C4, and yet another battery cell group G3 may include two other battery cells C5 and C6.

In the battery cell group G1, wires 311 and 312 are connected to a negative electrode of the first battery cell C1 and a positive electrode of the last battery cell C2, respectively. In the battery cell group G2, wires 312 and 313 are connected to a negative electrode of the first battery cell C3 and a positive electrode of the last battery cell C4, respectively. In this case, since the positive electrode of the last battery cell C2 of the battery cell group G1 and the negative electrode of the first battery cell C3 of the battery cell group G2 are shared, the same wire 312 is connected to the positive electrode of the battery cell C2 and the negative electrode of the battery cell C3. In some embodiments, a separate wire other than the wire 312 may be connected to the negative electrode of the first battery cell C3 of the battery cell group G2. Similarly, in the battery cell group G3, wires 313 and 314 are connected to a negative electrode of the first battery cell C5 and a positive electrode of the last battery cell C6, respectively. In this case, since the positive electrode of the last battery cell C4 of the battery cell group G2 and the negative electrode of the first battery cell C5 of the battery cell group G3 are shared, the same wire 313 is connected to the positive electrode of the battery cell C4 and the negative electrode of the battery cell C5. In some embodiments, a separate wire other than the wire 313 may be connected to the negative electrode of the first battery cell C5 of the battery cell group G3.

The battery management system 320 includes a switching circuit 322. The switching circuit 322 is connected to the wires 311, 312, 313, and 314, and has a negative output terminal 323 and a positive output terminal 324. The negative output terminal 323 is connected to a ground terminal of an operating device of the battery management system 320, and the positive output terminal 324 is connected to an operating voltage supply terminal of the operating device of the battery management system 320. In some embodiments, as shown in FIG. 3, the negative output terminal 323 may be connected to a ground terminal of a processor 321 of the battery management system 320, i.e., a ground pin GND, and the positive output terminal 324 may be connected to an operating voltage supply terminal of the processor 321, i.e., an operating voltage supply pin Vcc.

The switching circuit 322 periodically switches connections among the wires 311, 312, 313, and 314, the negative output terminal 323, and the positive output terminal 324. In some embodiments, as shown in FIG. 4, the switching circuit 322 may connect the wire 311 to the negative output terminal 323 and the wire 312 to the positive output terminal 324 during a first period T1 so that the battery cell group G1 can supply the operating voltage. After the first period T1, the switching circuit 322 may connect the wire 312 to the negative output terminal 323 and the wire 313 to the positive output terminal 324 during a second period T2 so that the battery cell group G2 can supply the operating voltage. After the second period T2, the switching circuit 322 may connect the wire 313 to the negative output terminal 323 and the wire 314 to the positive output terminal 324 during a third period T3 so that the battery cell group G3 can supply the operating voltage. The switching circuit 322 may alternately select the plurality of battery cell groups G1, G2, and G3 and supply the operating voltage by repeating the first period T1, the second period T2, and the third period T3. Accordingly, it is possible to prevent an imbalance in battery cell voltage that may occur when the operating voltage is supplied only from a specific battery cell group.

In some embodiments, the switching circuit 322 may allow two battery cell groups to simultaneously supply the operating voltage when switching to another period. Accordingly, it is possible to ensure that there is no blank period in the supply of the operating voltage.

In some embodiments, durations of the first period T1, the second period T2, and the third period T3 may be set to be the same.

In some embodiments, the processor 321 of the battery management system 320 may control operations of the switching circuit 322.

In some embodiments, as shown in FIG. 5, the switching circuit 322 may include a plurality of switches S1, S2, S3, S4, S5, and S6. The switch S1 is connected between the wire 311 and the negative output terminal 323, and the switch S2 is connected between the wire 312 and the positive output terminal 324. The switch S3 is connected between the wire 312 and the negative output terminal 323, and the switch S4 is connected between the wire 313 and the positive output terminal 324. The switch S5 is connected between the wire 313 and the negative output terminal 323, and the switch S6 is connected between the wire 314 and the positive output terminal 324. Accordingly, the battery management system may turn on the switches S1 and S2 to select the battery cell group G1, turn on the switches S3 and S4 to select the battery cell group G2, and turn on the switches S5 and S6 to select the battery cell group G3.

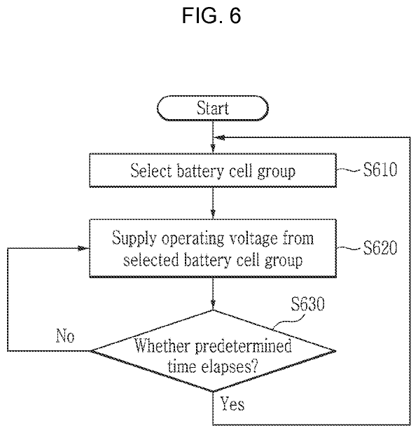

FIG. 6 is a flowchart showing a voltage supply method according to another embodiment.

Referring to FIG. 6, a battery management system selects one battery cell group from among a plurality of battery cells of an LV battery pack at S610. The selected battery cell group supplies an operating voltage to an operating device of the battery management system at S620.

If a predetermined time has not elapsed after selecting one battery cell group at S630, the operating voltage is continuously supplied from the selected battery cell group at S620. When a predetermined time has elapsed after selecting one battery cell group, the battery management system selects another battery cell group from the LV battery pack at S610. Accordingly, the newly selected battery cell group may supply the operating voltage to the operating device of the battery management system at S620.

By repeating the processes of S610, S620, and S630, the battery management system may supply the operating voltage to the operating device of the battery management system while balancing battery cell voltages.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

1. A battery apparatus comprising:
a first battery pack configured to provide a first voltage;
a battery management system configured to manage the first battery pack; and
a second battery pack configured to provide a second voltage lower than the first voltage and including a plurality of battery cells,
wherein the battery management system is configured to select a battery cell group including a predetermined number of battery cells from among the plurality of battery cells of the second battery pack, and
wherein the selected battery cell group supplies an operating voltage to an operating device of the battery management system.

2. The battery apparatus of claim 1, wherein the first voltage of the first battery pack is not provided as the operating voltage.

3. The battery apparatus of claim 1, wherein the operating voltage corresponds to a sum of voltages of the predetermined number of battery cells.

4. The battery apparatus of claim 1, wherein a first wire connected to a negative electrode of a first battery cell among the predetermined number of battery cells is connected to a ground terminal of the operating device, and a second wire connected to a positive electrode of a last battery cell among the predetermined number of battery cells is connected to an operating voltage supply terminal of the operating device.

5. The battery apparatus of claim 1, wherein the plurality of battery cells of the second battery pack is grouped into a plurality of battery cell groups, and each of the plurality of battery cell groups includes battery cells corresponding to the predetermined number, and
wherein the battery management system is configured to select the battery cell group from among the plurality of battery cell groups.

6. The battery apparatus of claim 5, wherein the battery management system is configured to alternately select one battery cell group from among the plurality of battery cell groups at a predetermined time interval.

7. The battery apparatus of claim 5, wherein the battery management system further includes a switching circuit configured to select the plurality of battery cell groups.

8. The battery apparatus of claim 7, wherein the plurality of battery cell groups includes a first battery cell group and a second battery cell group,
wherein the switching circuit is configured to, in response to selecting the first battery cell group, connect a first wire connected to a negative electrode of a first battery cell among the predetermined number of battery cells in the first battery cell group to a ground terminal of the operating device, and connect a second wire connected to a positive electrode of a last battery cell among the predetermined number of battery cells in the first battery cell group to an operating voltage supply terminal of the operating device, and
wherein the switching circuit is configured to, in response to selecting the second battery cell group, connect a third wire connected to a negative electrode of a first battery cell among the predetermined number of battery cells in the second battery cell group to the ground terminal, and connect a fourth wire connected to a positive electrode of a last battery cell among the predetermined number of battery cells in the second battery cell group to the operating voltage supply terminal.

9. The battery apparatus of claim 8, wherein the switching circuit includes:
a first switch connected between the first wire and the ground terminal;
a second switch connected between the second wire and the operating voltage supply terminal;
a third switch connected between the third wire and the ground terminal; and
a fourth switch connected between the fourth wire and the operating voltage supply terminal, and
wherein the battery management system is configured to select the first battery cell group by turning on the first switch and the second switch, and select the second battery cell group by turning on the third switch and the fourth switch.

10. The battery apparatus of claim 1, wherein the operating device includes a processor.

11. A method of supplying a voltage in a battery apparatus including a first battery pack configured to supply a first voltage, a second battery pack configured to supply a second voltage lower than the first voltage, and a battery management system configured to manage the first battery pack, the method comprising:
selecting a first battery cell group including a predetermined number of battery cells from among a plurality of battery cells included in the second battery pack; and
supplying an operating voltage to an operating device of the battery management system through the first battery cell group.

12. The method of claim 11, wherein the first voltage of the first battery pack is not provided as the operating voltage.

13. The method of claim 11, further comprising:
selecting a second battery cell group including the predetermined number of other battery cells from among the plurality of battery cells in response to a predetermined time elapsing after selecting the first battery cell group; and
supplying the operating voltage to the operating device of the battery management system through the second battery cell group.

14. The method of claim 11, wherein the operating voltage corresponds to a sum of voltages of the predetermined number of battery cells.

15. A battery apparatus comprising:
a battery pack including a plurality of battery cells; and
a battery management system configured to:
group the plurality of battery cells of the battery pack into a plurality of battery cell groups each including a predetermined number of battery cells;
alternately select one battery cell group from among the plurality of battery cell groups; and
providing an operating voltage to an operating device of the battery management system through the selected battery cell group.
